(19) United States
(12) Patent Application Publication
(10) Pub. No.: US 2026/0170045 A1
(43) Pub. Date: Jun. 18, 2026

(54) METHOD, APPARATUS, DEVICE AND STORAGE MEDIUM AND PROGRAM PRODUCT FOR INFORMATION PROCESSING

(71) Applicant: Beijing Zitiao Network Technology Co., Ltd., Beijing (CN)

(72) Inventor: Xuan LI, Beijing (CN)

(21) Appl. No.: 19/346,491

(22) Filed: Sep. 30, 2025

(30) Foreign Application Priority Data
Dec. 18, 2024 (CN) 202411877414.2

(51) Int. Cl. G06F 16/43; G06V 10/70; G06V 10/94; G06V 20/50

(52) U.S. Cl. CPC G06F 16/43; G06V 10/70; G06V 10/95; G06V 20/50

(57) ABSTRACT

The embodiment of the disclosure provides a method, apparatus, device, storage medium and a program product for information processing. The method comprises: obtaining, in response to receiving a user query from a user to a digital assistant from a user, auxiliary visual information acquired by a visual acquisition tool associated with the user based on the user query, an acquisition time of the auxiliary visual information being adjacent to an initiation time of the user query; and determining a reply corresponding to the user query based on the acquired auxiliary visual information and the user query with a machine learning model.

### CROSS-REFERENCE

This application claims the benefit of Chinese Patent Application No. 202411877414.2 filed on December 18, 2024, entitled “METHOD, APPARATUS, DEVICE AND STORAGE MEDIUM AND PROGRAM PRODUCT FOR INFORMATION PROCESSING”, the entire content of which is incorporated herein by reference.

### FIELD

Example embodiments in the disclosure generally relate to the field of computers, and in particular, to a method, apparatus, electronic device, computer-readable storage medium, and computer program product for information processing.

### BACKGROUND

With the development of information technologies, various electronic devices may provide various services to people in terms of work and life. For example, an application providing a service may be deployed on an electronic device. The electronic device or application may provide a digital assistant functions to assist the user in using the electronic device or application. The electronic device may receive a user query from a user to the digital assistant, and determine a reply corresponding to the user query based on the user query. How to improve the accuracy of the reply is a technical issue currently under exploration.

### SUMMARY

In a first aspect in the disclosure, a method for information processing is provided. The method includes: obtaining, in response to receiving a user query from a user to a digital assistant from a user, auxiliary visual information acquired by a visual acquisition tool associated with the user based on the user query, an acquisition time of the auxiliary visual information being adjacent to an initiation time of the user query; and determining a reply corresponding to the user query based on the acquired auxiliary visual information and the user query with a machine learning model.

In a second aspect in the disclosure, an apparatus for information processing is provided. The apparatus includes a visual information acquisition module, configured to obtain, in response to receiving a user query from a user to a digital assistant from a user, auxiliary visual information acquired by a visual acquisition tool associated with the user based on the user query, an acquisition time of the auxiliary visual information being adjacent to an initiation time of the user query; and a reply determination module, configured to determine a reply corresponding to the user query based on the acquired auxiliary visual information and the user query with a machine learning model.

In a third aspect in the disclosure, an electronic device is provided. The apparatus includes at least one processor; and at least one memory coupled to the at least one processor and storing instructions for execution by the at least one processor. The instructions, when executed by the at least one processor, cause the electronic device to perform the method of the first aspect.

In a fourth aspect in the disclosure, a computer-readable storage medium is provided. The medium stores a computer program, and when the computer program is executed by the processor, the method in the first aspect is performed.

In a fifth aspect in the disclosure, a computer program product is provided. The computer program product includes a computer program, the computer program, when executed by a processor, performs the method of the first aspect in the disclosure.

It should be understood that the content described in this content section is not intended to limit the key features or important features of the embodiments in the disclosure, nor is it intended to limit the scope of the disclosure. Other features in the disclosure will become readily understood from the following description.

### BRIEF DESCRIPTION OF DRAWINGS

The above and other features, advantages, and aspects of various embodiments in the disclosure will become more apparent from the following detailed description taken in conjunction with the accompanying drawings. In the drawings, the same or similar reference numbers refer to the same or similar elements, where:

FIG. 1 illustrates a schematic diagram of an example environment in which embodiments in the disclosure can be implemented;

FIG. 2 illustrates a flowchart of a method for information processing according to some embodiments in the disclosure;

FIG. 3 illustrates an example of visual information acquisition according to some embodiments in the disclosure;

FIG. 4 illustrates a schematic diagram of an example architecture of information processing according to some embodiments in the disclosure;

FIG. 5 illustrates an example structural block diagram of an apparatus for information processing according to some embodiments in the disclosure; and

FIG. 6 illustrates a block diagram of an electronic device in which one or more embodiments in the disclosure may be implemented.

### DETAILED DESCRIPTION

Embodiments in the disclosure will be described in more detail below with reference to the accompanying drawings. While certain embodiments in the disclosure are illustrated in the accompanying drawings, it should be understood that the disclosure may be implemented in various forms, and should not be construed as limited to the embodiments set forth herein, but rather, these embodiments are provided for a more thorough and complete understanding of the disclosure. It should be understood that the drawings and embodiments in the disclosure are for example only and are not intended to limit the scope of the disclosure.

In the description of the embodiments in the disclosure, the term “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

Unless explicitly stated otherwise, performs a step “in response to A” does not imply that the step is performed immediately after “A”, but may include one or more intermediate steps.

It may be understood that the data involved in the technical solution (including but not limited to the data itself, the obtaining, using, storing or deleting of the data) should comply with the requirements of applicable laws, regulations and related provisions.

It may be understood that, before using the technical solutions disclosed in the embodiments in the disclosure, appropriate measures should be taken in accordance with relevant laws and regulations to inform the user of the types of personal information involved, the scope of use, the usage scenario and the like to obtained the authorization from the user.

For example, in response to receiving an active request from a user, prompt information is sent to the user to explicitly prompt the user that the requested operation will need to obtain and use personal information of the user, so that the user may independently decide whether to provide such personal information to the software or hardware that performs the operation according to the technical solutions in the disclosure, such as an electronic device, application, server, or storage medium.

As an optional but non-limiting implementation, in response to receiving the active request from the user, the prompt message sent to the user may be provided in the form of a pop-up window, where the prompt message may be presented in text. Furthermore, the pop-up window may include selection controls allowing the user to choose whether to “agree” or “disagree” to provide personal information to the electronic device.

It is to be understood that the above-described process of notification and obtaining user authorization is merely illustrative and does not limit the implementation of the disclosure. Other methods that comply with relevant laws and regulations may also be applied to the implementations of the present disclosure.

As used herein, the term “model” may learn the correlation between input and output from training data, such that upon completion of training, it can generate corresponding output for a given input. The model may be generated based on machine learning techniques. Deep learning is a type of machine learning algorithm that uses multiple layers of processors to process input and provide corresponding output. A neural network model is an example of a model based on deep learning. In this document, the term “model” may also be referred to as a “machine learning model,” “learning model,” “machine learning network,” or “learning network,” and these terms are used interchangeably herein.

A “neural network” is a type of machine learning network based on deep learning. A neural network is capable of processing input and providing corresponding output, and typically includes an input layer, an output layer, and one or more hidden layers between the input and output layers. Neural networks used in deep learning applications generally include many hidden layers to increase the depth of the network. The layers of a neural network are connected sequentially, such that the output of a preceding layer is provided as input to the subsequent layer, where the input layer receives the input of the neural network and the output of the output layer serves as the final output. Each layer of the neural network comprises one or more nodes (also referred to as processing nodes or neurons), and each node processes input from the previous layer.

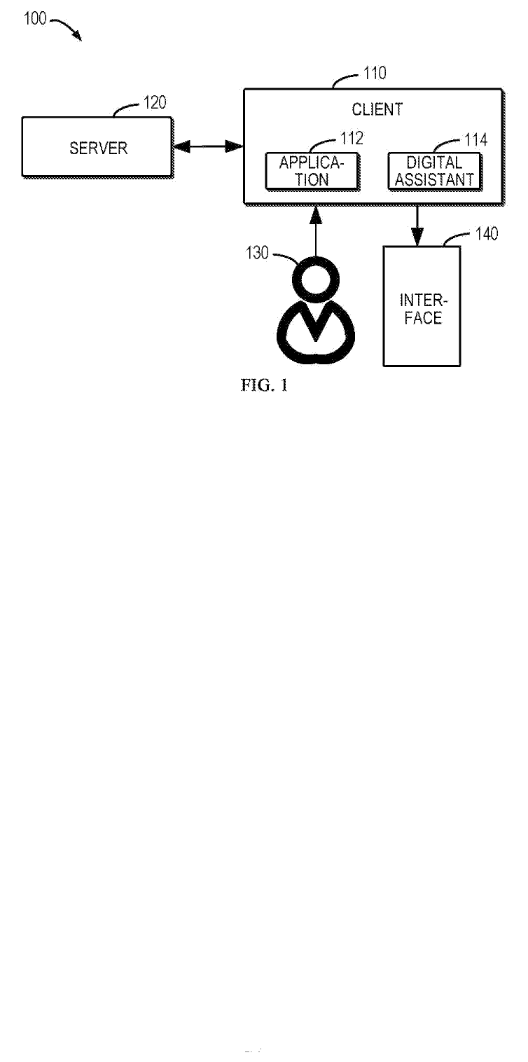

FIG. 1 illustrates a schematic diagram of an example environment 100 in which embodiments in the disclosure can be implemented. In this example environment 100, an application 112 and a digital assistant 114 are installed in the client 110. The user 130 may interact with the application 112 via the client 110 and/or peripheral devices attached to the client 110. In some implementations, the application 112 may be authorized to collect user voice of the user 130 via an audio capture device (e.g., a microphone) of the client 110, and to capture images via a visual acquisition tool (e.g., a camera) of the client 110, and/or the like.

In some embodiments, the application 112 and the digital assistant 114 may be downloaded and installed on the client 110. In some embodiments, the application 112 and the digital assistant 114 may also be accessed via other means, such as web page access.

In an embodiment in the disclosure, the application 112 may be any suitable application with task processing capabilities, which may include, but is not limited to, one or more of the following: a chat application component (also referred to as an instant messaging application component), a browser application component, a planning application component, a document application component, an audio and video conference application component, a mail application component, a task application component, a calendar application component, a target and key result (OKR) application component, and the like. It may be understood that although a single application service component is shown in FIG. 1, in practice, multiple application service components may be installed on the client 110. In some embodiments, the application 112 may include a multifunctional collaboration platform, for example, an office collaboration platform (also referred to as an office suite), which can provide an integrated set of various service components to facilitate office work, communication and other activities. In the multifunctional collaboration platform, users may launch different service components as needed to perform corresponding tasks such as information processing, sharing, communication and the like.

In some embodiments, the digital assistant 114 may be provided by a separate application service component, or be integrated into some application 112 capable of providing content entities. The application service component that provides the client interface for the digital assistant may correspond to a single function application service component or a multifunction collaboration platform, such as an office suite or another collaboration platform capable of integrating multiple components. It is to be understood that although a single digital assistant is shown in FIG. 1, a plurality of digital assistants may be provided.

In some embodiments, the digital assistant 114 supports the use of plugins. Each plug-in can provide one or more functions of the application. Such plug-ins include, but are not limited to, one or more of: a search plug-in, a contact plug-in, a messaging plug-in, a document plug-in, a spreadsheet plug-in, a mail plug-in, a calendar plug-in, a schedule plug-in, a task plug-in, and the like.

The digital assistant 114 is a user's intelligent assistant, with capabilities for intelligent conversation and information processing. In an embodiment in the disclosure, the digital assistant 114 is configured to interact with the user 130 to assist the user 130 in using the terminal device or the application. In some embodiments, multiple interaction modes between the user 130 and the digital assistant 114 may be provided, and flexible switching between the multiple interaction modes is supported. In the event that a certain interaction mode is triggered, a corresponding interaction area is presented to facilitate interaction between the user 130 and the digital assistant 114. The manner of interaction between the user 130 and the digital assistant 114 varies under different interaction modes, allowing flexible adaptation to interaction requirements of different application scenarios.

In the environment 100, in response to the launch of the application 112, the client 110 may present an interface 140 of the application 112 and/or the digital assistant 114. The interface 140 may include, for example, an interactive interface of the application 112 and the digital assistant 114, in which an interaction window between the user 130 and the digital assistant 114 may be presented. In the interaction window, the user 130 can interact with the digital assistant 114 by inputting a natural language, images, audio files, video files, web files, etc., to instruct the digital assistant to assist in completing various tasks.

The interaction window between the digital assistant 114 and the user 130 may include a chat window, such as a chat window within an instant messaging application or an instant messaging module of a particular application. In the chat window, the interaction between the digital assistant 114 and the user 130 may be presented in the form of chat messages. Alternatively or additionally, the interaction window between the digital assistant 114 and the user 130 may further include other types of windows, such as a floating window mode, where the user 130 may trigger the digital assistant 114 to perform corresponding operations by inputting an command, selecting a shortcut command, or the like.

In some embodiments, the digital assistant 114 may support an interaction mode of a chat window, also referred to as a chat mode. In this interaction mode, a chat window between the user 130 and the digital assistant 114 is presented, in which the user 130 interacts with the digital assistant 114 via chat messages in the chat window. In the chat mode, the digital assistant 114 may perform tasks based on chat messages in the chat window. In the interaction window, the user 130 inputs an interaction message, and the digital assistant 114 provides a reply message in response to the user input. By selecting the digital assistant 114, a chat window with the digital assistant 114 may be opened. The chat window may include interface elements for information interaction, such as input boxes, message lists, message bubbles, and the like.

In some embodiments, a communication connection is established between the client 110 and the server 120. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments in the disclosure are not limited in this regard. In an embodiment in the disclosure, the client 110 and the server 120 may implement signaling interaction through a communication connection between the client 110 and the server 120 to enable the provision of services for the application 112 and/or the digital assistant 114.

In some embodiments, the client 110 and/or the server 120 may invoke one or more machine learning models to support the task processing functions of the application 112 based on the output of the machine learning model. The machine learning model may be deployed locally at the client 110 and/or the server 120, or may be deployed on other devices. The machine learning model may be based on any suitable model structure including, but not limited to, a Transformer model, a convolutional neural network (CNN), a recurrent neural network (RNN), a deep neural network (DNN), or the like. In some embodiments, the machine learning model may be based on a language model (LM). The language model can have question and answer capability by learning from a large corpus of corpora. The machine learning model may also be based on other suitable models. It should be noted that, if the machine learning model includes a plurality of machine learning models, the plurality of machine learning models may serve different purposes and have different functions, which is not limited in the disclosure.

The client 110 may also be referred to as a client device, which may be any type of mobile terminal, fixed terminal, or portable terminal, including a mobile handset, desktop computer, laptop computer, notebook computer, netbook computer, tablet computer, media computer, multimedia tablet, personal communication system (PCS) device, personal navigation device, personal digital assistant (PDA), audio/video player, digital camera/camcorder, positioning device, television receiver, radio broadcast receiver, electronic book device, gaming device, or any combination of the foregoing, including accessories and peripherals of these devices, or any combination thereof. In some embodiments, the client 110 can also support any type of interface for a user (such as a “wearable” circuit, etc. ).

The server 120 may also be referred to as a server device, which may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 120 may include, for example, a computing system/server, such as a mainframe, an edge computing node, a computing device in a cloud environment, or the like.

It should be understood that the structures and functions of the various elements in the environment 100 are described for example purposes only and do not imply any limitation to the scope of the disclosure.

In the interaction process between a user and a digital assistant, traditionally, only user questions inputted by the user can be received, and a corresponding reply is determined based on the user questions (and possibly also based on the context of the interaction). It is desirable to determine the answer based on more multimodal information to improve the richness and accuracy of the reply.

In view of this, according to an embodiment in the disclosure, an improved solution for information processing is provided. According to the solution of the embodiment of the disclosure, in response to receiving a user query from the user from a user to a digital assistant, auxiliary visual information acquired by a visual acquisition tool associated with the user is acquired based on the user query, and the acquisition time of the auxiliary visual information is adjacent to the initiation time of the user query. A reply corresponding to the user query is determined based on the acquired auxiliary visual information and the user query with a machine learning model.

In this manner, the auxiliary visual information can be acquired in real time based on the requirement of the question and answer during the question-and-answer process of the user, and the reply to the user query is determined based on the user query and the auxiliary visual information. This helps to improve the diversity and richness of the interaction between the user and the digital assistant, as well as enhance the accuracy of the reply.

Some example embodiments in the disclosure will be described below with continued reference to the accompanying drawings.

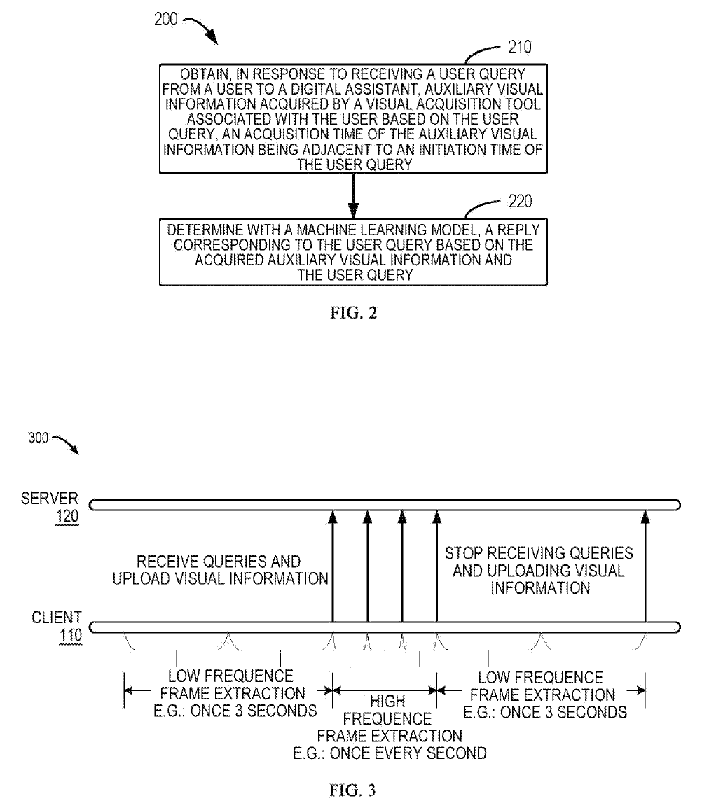

FIG. 2 shows a flowchart of a method 200 for information processing according to some embodiments in the disclosure. For ease of discussion, the method 200 will be described with reference to the environment 100 of FIG. 1. In some embodiments, the method 200 may be implemented at the client 110. It should be noted that some operations described with reference to the client 110 may require assistance of the server 120. The operations performed by the client 110 may be specifically performed by a related application and/or a digital assistant installed on the client 110.

At block 210, the client 110 obtains, in response to receiving a user query from a user to the digital assistant, auxiliary visual information acquired by a visual acquisition tool associated with the user based on the user query, where an acquisition time of the auxiliary visual information is adjacent to an initiation time of the user query.

In some embodiments, during the interaction process between the user and the digital assistant, the client 110 may receive the user query input by the user in natural language, where the user query may be a text-type user query (may also be referred to as query text, question text, etc.), or may be a voice-type user query (may also be referred to as query audio, question audio, and the like). It may be understood that the voice-type user query may be any suitable audio of any duration, language, tone, or the like, and the text-type user query may be any suitable text of any length, language, or the like.

In some embodiments, the client 110 may determine the type of visual acquisition tool based on the user query, and acquire the auxiliary visual information via the corresponding type of visual acquisition tool. The types of visual acquisition tools include cameras and/or screen recording tools of the client. For example, if the user query is “What species is the bird on the tree in front?”, the client 110 may determine that the type of visual acquisition tool is a camera based on the user query, and then acquire the auxiliary visual information via the camera. As another example, if the user query is “ What does this sentence on the screen mean?”, the client 110 may determine the type of visual acquisition tool is a screen recording tool of the client based on the user query, and then acquire the auxiliary visual information by recording the screen. As another example, if the user query is “ Is the shoulder bag shown on the screen the same as the one on the table?”, the client 110 may determine the type of visual acquisition tool include both a camera and a screen recording tool of the client based on the user query, and then acquire a portion of the auxiliary visual information via the camera and acquire another portion of the auxiliary visual information by recording the screen.

The auxiliary visual information includes an image, an image set, and/or a video. In some embodiments, the visual information acquired by the client 110 via the visual acquisition tool is video, and the client 110 may directly determine the acquired video as the auxiliary visual information, for example. In some embodiments, the client 110 may further process (e.g., by frame extraction) the acquired video, and determine at least one image as the auxiliary visual information. In some embodiments, the client 110 may also directly obtain at least one image acquired by the visual acquisition tool, and determine the acquired at least one image as the auxiliary visual information.

The state of the visual acquisition tool may be switched between a visual information acquisition state (active state) and a non-visual information acquisition state (inactive state). For example, the visual acquisition tool may acquire visual information when in a visual information acquisition state. In some embodiments, during the interaction process between the user and the digital assistant, for example, after the digital assistant is activated, the visual acquisition tool may remain in the visual information acquisition state. For example, the visual acquisition tool may always acquire visual information throughout the interaction process between the user with the digital assistant.

In some embodiments, if the auxiliary visual information is video-type visual information, the client 110 may instruct the visual acquisition tool to continuously acquire the visual information during the interaction between the user and the digital assistant. In some embodiments, if the auxiliary visual information is image-type visual information, the client 110 may instruct the visual acquisition tool to acquire first visual information at a first frequency and determine the first visual information as at least a portion of the auxiliary visual information during the reception of the user query. The client 110 may further instruct the visual acquisition tool to acquire second visual information at a second frequency in response to not receiving the user query, and further determine the second visual information as at least a portion of the auxiliary visual information. That is, the auxiliary visual information may include the first visual information acquired by the visual acquisition tool at the first frequency and the second visual information acquired by the visual acquisition tool at the second frequency.

To reduce power consumption, the second frequency may be less than the first frequency. For example, during the reception of the user query, the client 110 may instruct the visual acquisition tool to acquire the first visual information at a frequency of once every seconds, and during periods in which no user query is received, the client 110 may instruct the visual acquisition tool to acquire the second visual information at a frequency of once every 3 seconds.

In some embodiments, the client 110 may further instruct the visual acquisition tool to acquire the video-type visual information. In this case, the client 110 may perform frame extraction on the video acquired by the visual acquisition tool at the first frequency to obtain the first visual information during the reception of the user query. During periods in which no user query is received, the client 110 may perform frame extraction on the video acquired by the visual acquisition tool at the second frequency to obtain the second visual information.

For example, referring to FIG. 3, FIG. 3 shows an example 300 of visual information acquisition according to some embodiments in the disclosure. As shown in FIG. 3, if the visual information acquired by the visual acquisition tool is a video, the client 110 may perform a low-frequency frame extraction on the video acquired by the visual acquisition tool at a frequency of 3 seconds during periods in which no user query is received, and perform a high-frequency frame extraction on the video acquired by the visual acquisition tool at a frequency of 1 seconds during the reception of the user query. Of course, the frequency here is merely an example, and other frequencies may be configured as needed in practice.

In some embodiments, the client 110 may detect a requirement for the auxiliary visual information based on the user query, and in response to detecting the requirement, obtain the auxiliary visual information acquired by the visual acquisition tool based on the user query. That is, the client 110 may instruct the visual acquisition tool to switch to the visual information acquisition state to acquire the visual information only if the requirement is detected.

In some embodiments, the client 110 may determine that the requirement for the auxiliary visual information is detected in response to determining that the user query is related to a target object in the environment where the user is located. For example, if the user query is “What holiday is this weekend”, the client 110 may determine that the user query is irrelevant to any target object in the environment where the user is located, and further determine that no requirement for the auxiliary visual information is detected. If the user query is “ What kind of tree is that in front?”, the client 110 may determine that the user query is related to the target object (that is, the “tree”) in the environment where the user is located, and further determine that the auxiliary visual information needs to be acquired to help respond to the user query.

For example, the client 110 may obtain visual information acquired by the visual acquisition tool for a predetermined time period in the visual information acquisition state as the auxiliary visual information. The predetermined time period may be a preset time period, which may be any suitable duration. In some embodiments, the client 110 may further instruct the visual acquisition tool to exit the visual information acquisition state after the predetermined time period expires. Thus, the visual acquisition tool acquires the visual information only when the requirement is detected, and exits the visual information acquisition state in response to the visual information acquired for the predetermined time period. This may further reduce power consumption of visual information acquisition.

In some embodiments, the client 110 may further instruct the visual acquisition tool to switch to the visual information acquisition state in response to detecting the requirement for the auxiliary visual information, and instruct the visual acquisition tool to maintain the visual information acquisition state until the user ends the interaction with the digital assistant. As an example, after the visual acquisition tool is switched to the visual information acquisition state, the second visual information is acquired at a lower second frequency in response to no user query being received, and the first visual information is acquired at a higher first frequency during the reception of the user query. As another example, after the visual acquisition tool is switched to the visual information acquisition state, the video-type visual information may always be acquired. The client 110 may perform frame exaction on the video at a lower second frequency to determine the second visual information in response to no user query being received. During the reception of the user query, the client 110 may perform frame exaction on the video at a higher first frequency to determine the first visual information.

At block 220, the client 110 utilizes the machine learning model to determine a reply corresponding to the user query based on the acquired auxiliary visual information and the user query.

As mentioned above, the machine learning model may be based on any suitable model structure including, but not limited to, a Transformer model, a convolutional neural network (CNN), a recurrent neural network (RNN), a deep neural network (DNN), or the like. In some embodiments, the machine learning model may be based on a language model (LM). The machine learning model may include a plurality of machine learning models including at least a reply model. In some embodiments, if the user query is a voice-type query (i.e., query audio), the plurality of machine learning models may further include a voice processing model for providing voice processing services to the user query. The voice processing model may include, for example, a speech recognition (ASR) model (which may also be referred to as a speech-to-text model) and a speech synthesis (TTS) model (which may also be referred to as a text-to-speech model). The ASR model may be configured to convert the query audio into a corresponding query text, and the TTS model may be configured to convert the reply text for the query text into a corresponding reply audio.

The machine learning model may be deployed locally on the client 110. In this case, the client 110 may directly invoke the local machine learning model to determine the reply based on the auxiliary visual information and the user query. The machine learning model may also be deployed at other electronic devices, such as the server 120. In this case, the client 110 may, for example, invoke the machine learning model deployed at the server 120 via a communication connection between the client 110 and the server 120.

It should be noted that, as mentioned above, the auxiliary visual information may be video-type visual information or image-type visual information. If the reply is to be determined with a machine learning model at the server 120, and if the visual information acquired by the visual acquisition tool is video, in some embodiments, the client 110 may locally perform frame exaction on the video-type visual information to obtain image-type auxiliary visual information, and provide the auxiliary visual information to the server 120. In some embodiments, the client 110 may also directly provide the video-type visual information to the server 120. After receiving the video-type visual information, the server 120 may perform frame extraction on the video-type visual information of the video type to obtain image-type auxiliary visual information, and then directly determine the reply based on the auxiliary visual information and the received user query.

In some embodiments, both the client 110 and the server 120 may be deployed with a machine learning model, and the client 110 may detect a network communication capability between the client 110 and the server 120, and determine, based on at least the network communication capability, whether to invoke the machine learning model local to the client 110 or invoke the machine learning model at the server 120. The network communication capability may be determined based on one or more factors such as network signal strength, network link speed, network latency, and the like, which may be used to measure a networking condition between the client 110 and the server 120. The client 110 may detect a network communication capability between the client 110 and the server 120 through a network probe.

In some embodiments, if the network communication capability is high (for example, higher than a threshold), the client 110 may determine that the network communication is currently available or favorable, and therefore invoke the machine learning model at the server 120 to determine the reply. If the network communication capability is low (for example, below a threshold), the client 110 may determine that there is no network communication or the current network communication is poor, and therefore invoke the local machine learning model to determine the reply. It is to be understood that the client 110 may use any suitable method to determine which machine learning model to invoke and where to invoke it from, and the present disclosure does not place limitations on specific methods. The following description uses the invocation of the machine learning model at the server 120 as an example.

In some embodiments, in order to request the server 120 to determine the reply based on the acquired auxiliary visual information and the user query by using the machine learning model, the client 110 may send the auxiliary visual information and the user query to the server 120 together in response to detecting the user query. For example, referring to FIG. 3, the client 110 may upload the image-type visual information to the server 120 in response to receiving the user query. In some embodiments, the client 110 may also stop uploading the visual information in response to the user query no longer being received.

The communication links that the client 110 sends the auxiliary visual information and the user query may be the same or different. For example, the client 110 may send the auxiliary visual information to the server 120 via a first communication link, and send the received user query to the server 120 via a second communication link different from the first communication link. After receiving the auxiliary visual information and the user query, the server 120 may use the machine learning model to determine the reply corresponding to the user query based on the auxiliary visual information and the user query. The server 120 may then send the reply to the client 110. The client 110 may receive the reply corresponding to the user query from the server 120. In some embodiments, the client 110 may also provide the response to the user. For example, the client 110 may present, in an interaction window between the user and the digital assistant, a reply text corresponding to the reply, play a reply audio corresponding to the reply, or the like.

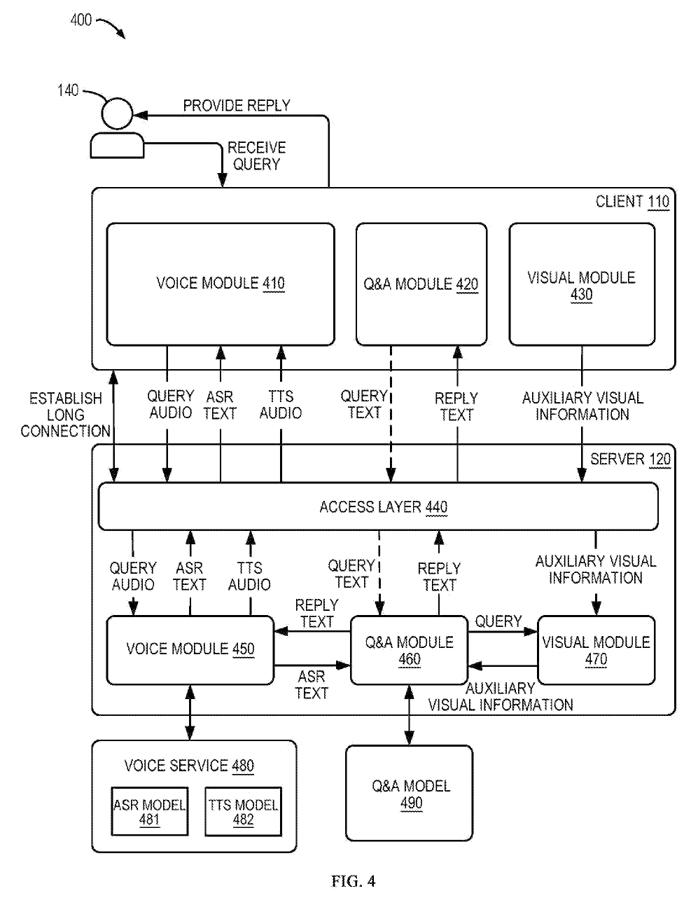

FIG. 4 illustrates a schematic diagram of an example architecture 400 for information processing according to some embodiments in the disclosure. For ease of discussion, architecture 400 will be described with reference to environment 100 of FIG. 1. As shown in FIG. 4, the architecture 400 relates to a client 110 and a server 120. In the example of FIG. 4, it is assumed that the client 110 needs to upload user queries and auxiliary visual information to the server 120 for determining the reply.

The client 110 may include a voice module 410, a question and answer (Q&A)module 420, and a visual module 430. The server 120 may include an access layer 440, a voice module 450, a question and answer module 460, and a visual module 470. The server 120 interacts with the client 110 via the access layer 440. The voice module 450 is configured to interact with the voice service 480, and the voice service 480 may provide a speech processing model deployed at the server 120. The speech processing model may include, for example, an ASR model 481 and a TTS model 282. The question and answer module 460 is configured to interact with the question and answer model 490.

In some embodiments, if the user query is a voice-type query (i.e., query audio), the voice module 410 in the client 110 may send the query audio to the server 120. In a specific manner of sending the query audio to the server 120 in some embodiments, a network connection may be established between the client 110 and the server 120, and the network connection may be a long connection conforming to a Transmission Control Protocol (TCP). For example, the client 110 may establish a long connection with the network interface of the access layer 440 of the server 120 through a three-way interaction process (which may also be referred to as a three-way handshake) defined by the TCP protocol. The server 120 may receive the query audio via the access layer 440 and provide the query audio to the voice module 450.

Similarly, if the user query is a text-type query (i.e., query text), the question and answer module 420 in the client 110 may directly send the query text to the server 120. The server 120 may receive the query text via the access layer 440, and provide the query text to the question and answer module 460.

In some embodiments, the visual module 430 in the client 110 may further send the auxiliary visual information acquired via the visual acquisition tool to the server 120 in response to receiving the user query. The server 120 may receive the auxiliary visual information via the access layer 440 and provide the auxiliary visual information to the visual module 470.

If the user query is voice-type query, the voice module 450 may determine a model input for the ASR model 481 based on the query audio. The voice module 450 may provide the model input to the ASR model 481 at the voice service 480 and obtain a model output of the ASR model 481 for the model input, which may indicate ASR text for the query audio. The voice module 260 in the server 120 may send the ASR text to the client 110 in response to obtaining the ASR text for the query audio. The voice module 260 in the server 120 may further provide the ASR text to the question and answer module 460 in response to obtaining the ASR text for the query audio.

The question and answer module 460 may, for example, determine the semantics of the ASR text to determine whether a requirement for the auxiliary visual information is detected. If the requirement for the auxiliary visual information is detected, the question and answer module 460 may send a request for the auxiliary visual information to the visual module 470 in response to detecting the requirement. The visual module 470 may send the auxiliary visual information to the question and answer module 470 in response to receiving the request.

The question and answer module 470 may determine the answer text for the user query based on the ASR text/query text and the auxiliary visual information for the query audio. Specifically, the question and answer module 470 may determine the model input for the question and answer model 490 based on at least the ASR text/ query text and the auxiliary visual information for the query audio. For example, in order to improve the accuracy of the determined reply text, the server 120 may further provide the context information of the user to the question and answer model 490. The context information of the user may include one or more of historical interaction information of the user (for example, historical user queries, historical reply texts, etc. ), multimodal information from the user (for example, images, audio, videos, documents, etc. sent/uploaded by the user), environment information of the user, user attribute information of the user, version information of the application, and the like. The question and answer module 470 may provide the model input to the question and answer model 490, and obtain a model output from the question and answer model 490, which may indicate a reply text corresponding to the user query. The question and answer module 470 may send the reply text to the client 110 in response to obtaining the reply text.

In some embodiments, the question and answer module 470 may further provide the reply text to the voice module 450 in response to obtaining the reply text. The voice module 450 may determine a model input for the TTS model 482 based on the reply text. The voice module 450 may provide the model input to the TTS model 482 at the voice service 480 and obtain a model output for the model input from the TTS model 482, which may indicate TTS speech for the reply text (which may also be referred to as a reply audio). In some embodiments, the voice module 260 may send the reply audio to the client 110 in response to obtaining the reply audio.

The client 110 may provide the reply to the user in response to obtaining the reply (reply text and/or reply audio). In some embodiments, the client 110 receives the user query during the interaction between the user and the digital assistant and provides a reply to the user. The user queries and replies may, for example, be presented in the interaction interface between the user and the digital assistant in the form of a chat message from the user and a chat message from the digital assistant, respectively.

In summary, according to the embodiments in the disclosure, the auxiliary visual information acquired in real time by the visual acquisition tool may be obtained based on the user query, and the reply to the user query is determined based on the user query and the auxiliary visual information. This helps to improve the diversity and richness of the interaction between the user and the digital assistant, as well as enhance the accuracy of the reply.

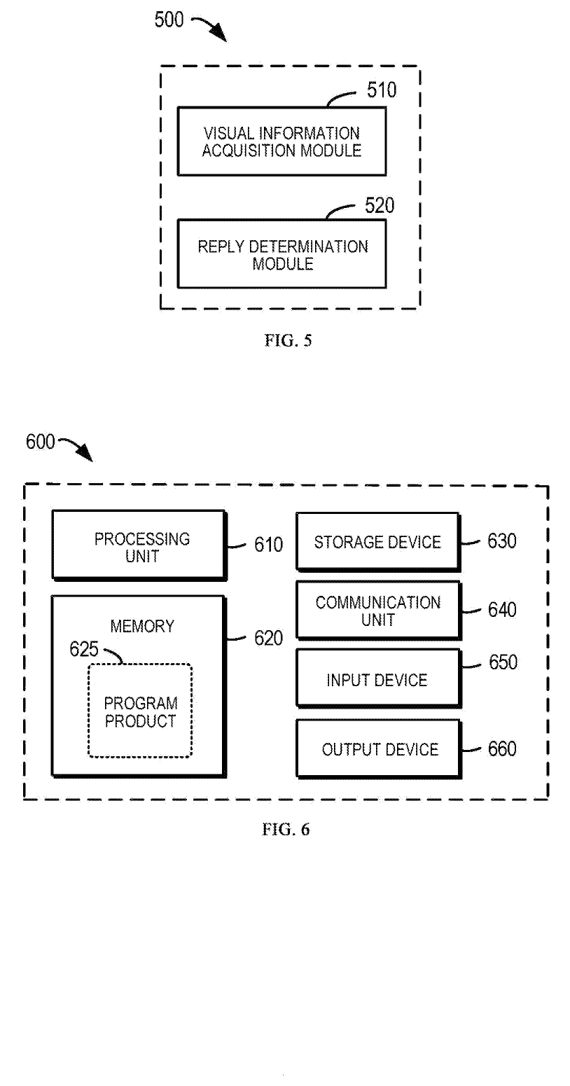

Embodiments in the disclosure also provide a corresponding apparatus for implementing the above methods or processes. FIG. 5 shows an example structural block diagram of an apparatus for information processing 500 according to some embodiments in the disclosure. The apparatus 500 may be implemented or included in the client 110. The various modules/components in the apparatus 500 may be implemented by hardware, software, firmware, or any combination thereof.

As shown in FIG. 5, the apparatus 500 includes a visual information obtaining module 510, configured to obtain, in response to receiving a user query from a user to a digital assistant from a user, auxiliary visual information acquired by a visual acquisition tool associated with the user based on the user query, an acquisition time of the auxiliary visual information being adjacent to an initiation time of the user query. The apparatus 500 further includes a reply determination module 520 configured to determine a reply corresponding to the user query based on the acquired auxiliary visual information and the user query with a machine learning model.

In some embodiments, the visual information acquisition module 510 is further configured to: a requirement for the auxiliary visual information based on the user query; and obtain, in response to detecting the requirement, the auxiliary visual information acquired by the visual acquisition tool based on the user query.

In some embodiments, the visual information obtaining module 510 is further configured to: determine that the requirement for the auxiliary visual information is detected in response to determining that the user query is related to a target object in an environment where the user is located.

In some embodiments, the visual acquisition tool is maintained in a visual information acquisition state during an interaction between the user and the digital assistant, where the visual information acquisition module 510 is further configured to: instruct the visual acquisition tool to acquire first visual information at a first frequency during the reception of the user query; and determine the first visual information as at least a portion of the auxiliary visual information.

In some embodiments, the visual information acquisition module 510 is further configured to: instruct, in response to not receiving the user query, the visual acquisition tool to acquire second visual information at a second frequency, the second frequency being less than the first frequency; and determine the second visual information as at least a portion of the auxiliary visual information.

In some embodiments, the visual information acquisition module 510 is further configured to: instruct, in response to detecting the requirement, the visual acquisition tool to switch to a visual information acquisition state; and obtain visual information acquired by the visual acquisition tool for a predetermined time period in the visual information acquisition state as the auxiliary visual information.

In some embodiments, the apparatus 500 further includes: a state exit module, configured to instruct, after the predetermined time period expires, the visual acquisition tool to exit the visual information acquisition state.

In some embodiments, the method is applied to the client, and the machine learning model is deployed at the server, and the reply determination module 520 is further configured to: in response to detecting the user query, send the auxiliary visual information to the server via a first communication link in response to detecting the user query; send the received user query to the server via a second communication link to request the server to determine the reply based on the acquired auxiliary visual information and the user query using the machine learning model; and receive the reply corresponding to the user query from the server.

In some embodiments, the apparatus 500 further includes a type determination module configured to determine a type of the visual acquisition tool based on the user query, the type indicating a camera or a screen recording tool of a client.

The modules included in the apparatus 500 may be implemented in various manners, including software, hardware, firmware, or any combination thereof. In some embodiments, one or more modules may be implemented using software and/or firmware, such as machine-executable instructions stored on a storage medium. In addition to or as an alternative to machine-executable instructions, some or all of the modules in the apparatus 500 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

It should be understood that one or more of the above methods may be performed by a suitable electronic device or a combination of electronic devices. Such electronic devices or combinations of electronic devices may include client for example, client 110 in FIG. 1.

FIG. 6 illustrates a block diagram of an electronic device 600 in which one or more embodiments in the disclosure may be implemented. It should be understood that the electronic device 600 illustrated in FIG. 6 is merely examples and should not constitute any limitation on the functionality and scope of the embodiments described herein. The electronic device 600 shown in FIG. 6 may be configured to implement the client 110 in FIG. 1 or the apparatus 500 in FIG. 5.

As shown in FIG. 6, the electronic device 600 is in the form of a general-purpose electronic device. Components of the electronic device 600 may include, but are not limited to, one or more processors or processing units 610, a memory 620, a storage device 630, one or more communication units 640, one or more input devices 650, and one or more output devices 660. The processor 610 may be an actual or virtual processor and capable of performing various processes according to programs stored in the memory 620. In multiprocessor systems, multiple processors execute computer-executable instructions in parallel to improve parallel processing capabilities of electronic device 600.

Electronic device 600 typically includes a plurality of computer storage media. Such media may be any available media accessible to the electronic device 600, including, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 630 may be a removable or non-removable medium and may include a machine-readable medium, such as a flash drive, magnetic disk, or any other medium, which may be capable of storing information and/or data and may be accessed within electronic device 600.

The electronic device 600 may further include additional removable/non-removable, volatile/non-volatile storage media. Although not shown in FIG. 6, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments in the disclosure.

The communication unit 640 is configured to communicate with another electronic device through a communication medium. Additionally, the functionality of components of the electronic device 600 may be implemented in a single computing cluster or multiple computing machines capable of communicating over a communication connection. Thus, the electronic device 600 may operate in a networked environment using logical connections with one or more other servers, network personal computers (PCs), or another network node.

The input device 650 may be one or more input devices, such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, external devices such as storage devices, display devices, etc. , communicate with one or more devices that enable a user to interact with the electronic device 600, or communicate with any device (e.g., a network card, a modem, etc. ) that enables the electronic device 600 to communicate with one or more other electronic devices. Such communication may be performed via an input/output (I/O) interface (not shown).

According to example implementations in the disclosure, there is provided a computer-readable storage medium having computer-executable instructions stored thereon, where the computer-executable instructions are executed by a processor to implement the method described above. According to example implementations in the disclosure, a computer program product is further provided, the computer program product being tangibly stored on a non-transitory computer-readable medium and including computer-executable instructions, the computer-executable instructions being executed by a processor to implement the method described above.

Aspects in the disclosure are described herein with reference to flowcharts and/or block diagrams of methods, apparatuses, devices, and computer program products implemented in accordance with the disclosure. It should be understood that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram (s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations in the disclosure. In this regard, each block in the flowchart or block diagram may represent a module, program segment, or portion of an instruction that includes one or more executable instructions for implementing the specified logical function. In some implementations as an update, the functions noted in the blocks may also occur in a different order than that shown in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations in the disclosure have been described above, which are examples, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for information processing, comprising:
obtaining, in response to receiving a user query from a user to a digital assistant, auxiliary visual information acquired by a visual acquisition tool associated with the user based on the user query, an acquisition time of the auxiliary visual information being adjacent to an initiation time of the user query; and
determining, with a machine learning model, a reply corresponding to the user query based on the acquired auxiliary visual information and the user query.

2. The method of claim 1, wherein obtaining the auxiliary visual information acquired by the visual acquisition tool associated with the user based on the user query comprises:
detecting a requirement for the auxiliary visual information based on the user query; and
obtaining, in response to detecting the requirement , the auxiliary visual information acquired by the visual acquisition tool based on the user query.

3. The method of claim 2, wherein detecting the requirement for the auxiliary visual information based on the user query comprises:
determining that the requirement for the auxiliary visual information is detected in response to determining that the user query is related to a target object in an environment where the user is located.

4. The method of claim 1, wherein the visual acquisition tool is maintained in a visual information acquisition state during an interaction between the user and the digital assistant, and wherein obtaining the auxiliary visual information acquired by the visual acquisition tool comprises:
instructing the visual acquisition tool to acquire first visual information at a first frequency during the reception of the user query; and
determining the first visual information as at least a portion of the auxiliary visual information.

5. The method of claim 4, wherein obtaining the auxiliary visual information acquired by the visual acquisition tool further comprises:
instructing, in response to not receiving the user query, the visual acquisition tool to acquire second visual information at a second frequency, the second frequency being less than the first frequency; and
determining the second visual information as at least a portion of the auxiliary visual information.

6. The method of claim 2, wherein obtaining the auxiliary visual information acquired by the visual acquisition tool associated with the user comprises:
instructing, in response to detecting the requirement, the visual acquisition tool to switch to a visual information acquisition state; and
obtaining visual information for a predetermined time period acquired by the visual acquisition tool in the visual information acquisition state as the auxiliary visual information.

7. The method of claim 6, further comprising:
instructing, upon expiration of the predetermined time period, the visual acquisition tool to exit the visual information acquisition state.

8. The method of claim 1, wherein the method is applied to a client, and the machine learning model is deployed at a server, and
wherein determining, with the machine learning model, the reply corresponding to the user query based on the acquired auxiliary visual information and the user query comprises:
sending, in response to detecting the user query, the auxiliary visual information to the server via a first communication link;
sending, via a second communication link, the received user query to the server to request the server to determine, with the machine learning model, the reply based on the acquired auxiliary visual information and the user query; and
receiving the reply corresponding to the user query from the server.

9. The method of claim 1, further comprising:
determining a type of the visual acquisition tool based on the user query, the type indicating a camera or a screen recording tool of a client.

10. An electronic device comprising:
at least one processor; and
at least one memory coupled to the at least one processor and storing instructions for execution by the at least one processor, wherein the instructions, when executed by the at least one processor, cause the electronic device to perform operations comprising:
obtaining, in response to receiving a user query from a user to a digital assistant, auxiliary visual information acquired by a visual acquisition tool associated with the user based on the user query, an acquisition time of the auxiliary visual information being adjacent to an initiation time of the user query; and
determining, with a machine learning model, a reply corresponding to the user query based on the acquired auxiliary visual information and the user query.

11. The electronic device of claim 10, wherein obtaining the auxiliary visual information acquired by the visual acquisition tool associated with the user based on the user query comprises:
detecting a requirement for the auxiliary visual information based on the user query; and
obtaining, in response to detecting the requirement , the auxiliary visual information acquired by the visual acquisition tool based on the user query.

12. The electronic device of claim 11, wherein detecting the requirement for the auxiliary visual information based on the user query comprises:
determining that the requirement for the auxiliary visual information is detected in response to determining that the user query is related to a target object in an environment where the user is located.

13. The electronic device of claim 10, wherein the visual acquisition tool is maintained in a visual information acquisition state during an interaction between the user and the digital assistant, and wherein obtaining the auxiliary visual information acquired by the visual acquisition tool comprises:
instructing the visual acquisition tool to acquire first visual information at a first frequency during the reception of the user query; and
determining the first visual information as at least a portion of the auxiliary visual information.

14. The electronic device of claim 13, wherein obtaining the auxiliary visual information acquired by the visual acquisition tool further comprises:
instructing, in response to not receiving the user query, the visual acquisition tool to acquire second visual information at a second frequency, the second frequency being less than the first frequency; and
determining the second visual information as at least a portion of the auxiliary visual information.

15. The electronic device of claim 11, wherein obtaining the auxiliary visual information acquired by the visual acquisition tool associated with the user comprises:
instructing, in response to detecting the requirement, the visual acquisition tool to switch to a visual information acquisition state; and
obtaining visual information for a predetermined time period acquired by the visual acquisition tool in the visual information acquisition state as the auxiliary visual information.

16. The electronic device of claim 15, wherein the operations further comprise:
instructing, upon expiration of the predetermined time period, the visual acquisition tool to exit the visual information acquisition state.

17. The electronic device of claim 10, wherein the operations are applied to a client, and the machine learning model is deployed at a server, and
wherein determining, with the machine learning model, the reply corresponding to the user query based on the acquired auxiliary visual information and the user query comprises:
sending, in response to detecting the user query, the auxiliary visual information to the server via a first communication link;
sending, via a second communication link, the received user query to the server to request the server to determine, with the machine learning model, the reply based on the acquired auxiliary visual information and the user query; and
receiving the reply corresponding to the user query from the server.

18. The electronic device of claim 10, wherein the operations further comprise:
determining a type of the visual acquisition tool based on the user query, the type indicating a camera or a screen recording tool of a client.

19. A non-transitory computer-readable storage medium having stored thereon a computer program executable by a processor to perform operations comprising:
obtaining, in response to receiving a user query from a user to a digital assistant, auxiliary visual information acquired by a visual acquisition tool associated with the user based on the user query, an acquisition time of the auxiliary visual information being adjacent to an initiation time of the user query; and
determining, with a machine learning model, a reply corresponding to the user query based on the acquired auxiliary visual information and the user query.

20. The non-transitory computer-readable storage medium of claim 19, wherein obtaining the auxiliary visual information acquired by the visual acquisition tool associated with the user based on the user query comprises:
detecting a requirement for the auxiliary visual information based on the user query; and
obtaining, in response to detecting the requirement , the auxiliary visual information acquired by the visual acquisition tool based on the user query.
